(19) United States
(12) Patent Application Publication
(10) Pub. No.: US 2010/0146535 A1
(43) Pub. Date: Jun. 10, 2010

(54) METHOD AND DEVICE FOR AGE DEPENDENT PREVENTION OF CONSUMATION OF CENSORED AUDIO AND/OR AUDIOVISUAL PROGRAMS

(75) Inventor: Stefan Wieser, Gerasdorf (AT)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/598,040

(22) PCT Filed: May 5, 2008
(86) PCT No.: PCT/IB08/51719

§ 371 Date: Oct. 29, 2009

(30) Foreign Application Priority Data
May 10, 2007 (EP) 07107918.0

(51) Int. Cl. H04N 7/16

(52) U.S. Cl. 725/28

(57) ABSTRACT

A method and a device (1) for deterring children and adolescents from using an audio and/or audiovisual device (1), especially a TV set or a radio, while censored programs (X-Prog) are played by said device (1), said method comprising outputting an annoyance audio signal (AN) from the audio and/or audiovisual device (1) simultaneously with the censored program (X-Prog), wherein the annoyance audio signal (AN) has a frequency that can be heard by children and adolescents but is above the hearing threshold of adults.

### FIELD OF THE INVENTION

The invention relates to a method and a device for deterring children and adolescents to consume X-rated or censored audio and/or audiovisual programs.

### BACKGROUND OF THE INVENTION

Such a method and device are known from the document WO 98/14009, where a method of controlling the viewing of television programs according to their content is described. The method involves sending codes using an auxiliary data channel which indicate the level of sexual, violent, distressing etc. content. These codes are assembled into an extension packet of a teletext signal and detected at a receiver. The receiver is programmed by entering corresponding codes which indicate allowable or forbidden content and cause the display to be blanked and the sound to be muted in dependence of the transmitted codes.

In U.S. Pat. No. 5,195,135 a method and apparatus for the automatic censorship of audio-video programming at the receiver in accordance with a viewer-selected censorship mode and multivariate censorship classification data encoded in the audio-video programming signal are described. The censorship classification data comprise codes that classify the programming for several different subjects and several different censorship levels, automatically obscuring the audio and/or video signal by a fuzzy vagueness in the video or audio frame.

The known methods and devices, however, have shown the disadvantage that any person watching the TV program is affected by the censorship, not only children and adolescents.

### OBJECT AND SUMMARY OF THE INVENTION

It is therefore an object of the invention to provide a method and a device of the type defined in the opening paragraph, in which the disadvantages defined above are avoided.

In order to achieve the object defined above, with a method according to the invention characteristic features are provided so that a method according to the invention can be characterized in the way defined below, that is:

a method for deterring children and adolescents from using an audio and/or audiovisual device, especially a TV set or a radio, while censored programs are played by said device, comprising outputting an annoyance audio signal from the audio and/or audiovisual device simultaneously with the censored program, wherein the annoyance audio signal has a frequency and a sound pressure that can be perceived by children and adolescents but is above the hearing threshold of adults.

In order to achieve the object defined above, with a device according to the invention characteristic features are provided so that a device according to the invention can be characterized in the way defined below, that is:

an audio and/or audiovisual device, especially a TV set or a radio, being configured to output an annoyance audio signal, wherein the annoyance audio signal has a frequency and a sound pressure that can be perceived by children and adolescents but is above the hearing threshold of adults.

The characteristic features according to the invention provide the advantage that only children and adolescents are affected by the output annoyance audio signal, since said signal is only perceivable by young persons. Children and adolescents are easily prevented to watch censored or X-rated programs, while adults are not bothered by the annoyance audio signal.

The measures as claimed in the dependent claims, respectively, provide the advantage that the annoyance audio signal can either be broadcast by the broadcasting station during the broadcasting of an X-rated program and output by the TV set, or the annoyance audio signal can be produced by the TV set itself when receiving a code from the broadcasting station that an X-rated program is going to start.

In order to be able to adapt the device for deterring children and adolescents to hearing threshold levels of individuals it is proposed to provide setting means for setting the frequency of the annoyance audio signal and/or its sound pressure. However, in order to avoid abuse of these setting means by children and adolescents it is suggested to realize the setting means with either hardware or software locking means. Hardware locking means comprise e.g. a mechanical or magnetic lock. Software locking means comprise e.g. codes.

According to a preferred embodiment, receiving means for receiving an annoyance audio signal sent by a broadcasting station during the broadcasting of a censored program, an amplifier for amplifying the received annoyance audio signal and an electroacoustic transducer for outputting are provided.

According to another preferred embodiment, receiving a code sent by a broadcasting station, a code detector and annoyance audio signal generating means being triggered by the code detector when detecting the code are provided.

Preferably, said annoyance audio signal generating means is a synthesizer and said electroacoustic transducer is a speaker.

The aspects defined above and further aspects of the invention are apparent from the exemplary embodiments to be described hereinafter and are explained with reference to these exemplary embodiments. However, the invention is not limited to these exemplary embodiments.

### BRIEF DESCRIPTION OF THE DRAWINGS

FIG. 1 shows a schematic diagram of the range of frequency and acoustic pressure perceptible by the human sense of hearing, and

FIG. 2 shows a schematic view of a preferred embodiment of a device according to the present invention.

### DESCRIPTION OF EMBODIMENTS

TV and radio stations broadcast a huge number of programs, which are not appropriate for children or adolescents. These programs are censored or so-called “X-rated” programs. The invention is about keeping children and adolescents away from inappropriate TV and radio programs.

As mentioned above, there are different methods of automatic censorship affecting all persons watching by blanking or blurring the TV screen as well as muting the sound. Usual restraints for children which do not affect adults watching use PIN codes. However, this is not very handy in daily life.

An audio and/or audiovisual device, especially a TV set or a radio, according to the invention is adapted to release an annoyance audio signal, which is audible only to children or adolescents and bothers them or makes them feel unpleasant, so that they avoid using the audio and/or audiovisual device.

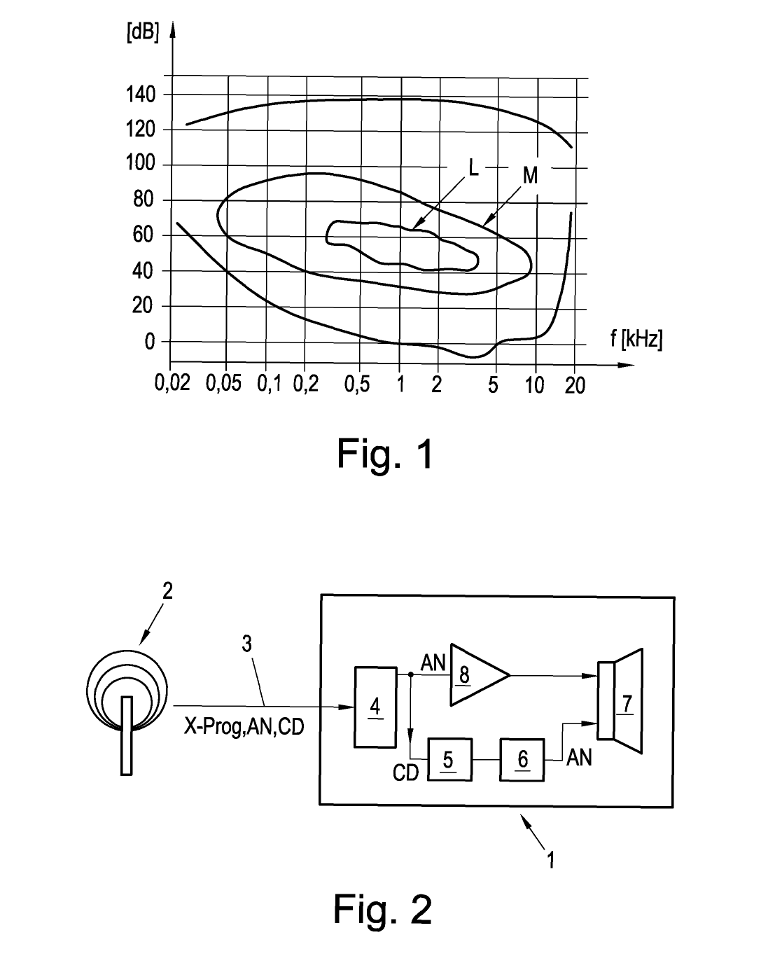

It is well-known that the human sense of hearing perceives acoustic stimulations only in a certain range of frequency and acoustic pressure. This range is located between the lower limit known as hearing threshold level, and the upper limit known as threshold of noise pain. The audible range of frequency and acoustic pressure is shown schematically in FIG. 1. The inner area L denotes the area of language perception, the wider area M denotes the area of music perception.

The hearing threshold level is located between the lowest audible frequencies at approximately 20 Hz and the highest audible frequencies at a maximum of approximately 20 kHz in connection with a corresponding sound pressure level. The threshold of hearing is generally reported as the sound pressure level of 20 μPa (micropascals). It is approximately the minimum sound intensity a young human with undamaged hearing can detect at 1 kHz. The hearing threshold level of man doesn't proceed in a linear manner but shows a minimum at approximately 2 kHz which is the range of highest sensibility. It depends on the age at which upper limit of frequency and sound pressure acoustic stimulations are perceptible. With increasing age the hearing threshold level rises significantly in the range of higher frequencies and higher sound pressure. Children and adolescents can perceive frequencies up to 20 kHz at a sound pressure of 5 dB, while people at an age of 60 years already reach a limit at a frequency of approximately 12 kHz and a sound pressure of approximately 15 dB.

Thus the output of an annoyance audio signal at a frequency of more than approximately 15 kHz and a sound pressure of less than approximately 15 dB will cause children and adolescents to refrain from watching censored or X-rated audio and/or audiovisual programs when sent simultaneously with said annoyance audio signal since there are bothered by the high frequency sound. Older persons being not able any more to perceive the high frequency sounds are therefore not bothered by an audio and/or audiovisual program with an overlaid annoyance audio signal.

In FIG. 2, a schematic view of an exemplary audio and/or audiovisual device 1 is shown. The device 1 comprises a receiver 4 for receiving a data stream 3 sent by a broadcasting station 2.

According to a first embodiment of the invention the broadcasting station 2 sending the censored program X-Prog also sends a special code CD simultaneously to the broadcasting of the X-Prog. This code CD is received by the receiver 4 in the audio and/or audiovisual device 1, especially the TV set or radio, during the broadcasting of the censored program X-Prog. Subsequently, the audio and/or audiovisual device 1 detects the code CD by a code detector 5 to which the code CD is fed from the receiver 4. The detection of the code CD triggers the generation of an annoyance audio signal AN in accordance with the reception and decoding of the code CD by a suitable means for sound generation like a synthesizer 6 and outputs said annoyance audio signal AN by a electroacoustic transducer like a speaker 7 until the X-rated program is finished and the code CD is not being sent any more by the broadcasting station 2.

Alternatively according to a second embodiment of the invention the broadcasting station 2 broadcasts itself the annoyance audio signal AN during the broadcasting of the censored program X-Prog which annoyance audio signal AN is transmitted together with the program in question to the audio and/or audiovisual device 1. Subsequently the annoyance audio signal AN is received by the receiver 4, amplified by an amplifier 8 and output from the audio and/or audiovisual device 1 by the speaker 7 during the broadcast of the censored program X-Prog. When the censored program X-Prog is finished the annoyance audio signal AN is switched off by the broadcasting station 2.

Thus an easy and effective method is given to prevent child and adolescent misuse of audio and/or audiovisual devices 1 during the broadcasting of X-rated or censored audio and/or audiovisual material.

In order to be able to adapt the audio and/or audiovisual device 1 to individual hearing threshold levels of children and adolescents setting means for setting the frequency of the annoyance audio signal AN and/or its sound pressure may be provided. These setting means are preferably incorporated either in the amplifier 8. e.g. by means of a potentiometer in the amplifying circuit, or in the synthesizer 6. In order to avoid abuse of these setting means by children and adolescents the setting means may further be provided with hardware or software locking means. Hardware locking means comprise e.g. a mechanical or magnetic lock. Software locking means comprise e.g. codes that can be input by a keypad or via a remote control.

In a first embodiment an (adult) user can set his age and the age of the children via a menu on the TV set. According to data about the frequency dependent and age dependent average threshold of hearing, which is stored in the TV set, an appropriate frequency and a sound pressure of the annoyance audio signal (AN) is automatically chosen and set.

In a second embodiment the annoyance audio signal (AN) is output during a set up procedure. In this case the (adult) user manually chooses an annoyance audio signal (AN) which he barely hears or barely does not hear, i.e. a annoyance audio signal (AN) in the proximity of his individual threshold of hearing, preferably below. Consequently, an annoyance audio signal (AN) is output during X-rated programs which is audible for younger people.

1. A method for deterring members of a first group of individuals from using at least one of an audio and an audiovisual device, while censored programs are played by said device, comprising outputting an annoyance audio signal from the device simultaneously with the censored program, wherein the annoyance audio signal has a frequency and a sound pressure that can be perceived by members of the first group of individuals but which is above a hearing threshold of a second group of individuals.

2. A method as claimed in claim 1, wherein the frequency of the annoyance audio signal is above 16 kHz, and the sound pressure is below 15 dB.

3. A method as claimed in claim 1, wherein at least one of the frequency of the annoyance audio signal and its sound pressure are settable via a setting device.

4. A method as claimed in claim 1, wherein the annoyance audio signal is broadcast by a broadcasting station together with the censored program.

5. A method as claimed in claim 1, wherein a code is broadcast by a broadcasting station together with said censored program, and wherein the device when receiving the code generates and outputs said annoyance audio signal.

6. An audio and/or audiovisual device configured to output an annoyance audio signal, wherein the annoyance audio signal has a frequency and a sound pressure that can be perceived by members of a first group of individuals but which is above the hearing threshold of members of a second group of individuals.

7. A device as claimed in claim 6, wherein the frequency of the annoyance audio signal is above 16 kHz and the sound pressure is below 15 dB.

8. A device as claimed in claim 6, further comprising a setting device for setting at least one of the frequency of the annoyance audio signal and its sound pressure.

9. A device as claimed in claim 6, wherein said device comprises a receiver for receiving an annoyance audio signal sent by a broadcasting station during broadcasting of a censored program, an amplifier for amplifying the received annoyance audio signal and an electroacoustic transducer for outputting said annoyance audio signal during playback of said censored program.

10. A device as claimed in claim 6, comprising a receiver for receiving a code sent by a broadcasting station, a code detector and an annoyance audio signal an annoyance signal generator that is triggered by the code detector when detecting the code.

11. A device as claimed in claim 9, wherein said annoyance audio signal generator is a synthesizer.

12. A device as claimed in claim 9, wherein said electroacoustic transducer is a speaker.

13. A method as in claim 1, wherein the first group of individuals consists of children and adolescents and the second group consists of adults.

14. A method as in claim 1, wherein the device is at least one of a television set and a radio,

15. A method as in claim 1, wherein the frequency of the annoyance audio signal is above 18 kHz and the sound pressure is below 12 dB.

16. A method as in claim 3, wherein the setting device comprises at least one of a hardware locking device and locking software.

17. A device as in claim 6, wherein the first group of individuals consists of children and adolescents and the second group consists of adults.

18. A device as in claim 6, wherein the frequency of the annoyance audio signal is above 18 kHz and the sound pressure is below 12 dB.

19. A device as in claim 8, wherein the setting device comprises at least one of a hardware locking device and locking software.
